(19) United States
(12) Patent Application Publication
(10) Pub. No.: US 2008/0211770 A1
(43) Pub. Date: Sep. 4, 2008

(54) POINTING DEVICE, PORTABLE TERMINAL, POINT INFORMATION GENERATION METHOD, AND PORTABLE TERMINAL STRAP

(76) Inventor: Yoshiyuki SATOU, Kanagawa (JP)

Correspondence Address: MORRISON & FOERSTER LLP, 12531 HIGH BLUFF DRIVE, SUITE 100, SAN DIEGO, CA, 92130-2040, US

(21) Appl. No.: 12/037,854

(22) Filed: Feb. 26, 2008

(30) Foreign Application Priority Data
Feb. 26, 2007 (JP) 2007-046222

(51) Int. Cl. G06F 3/033

(52) U.S. Cl. 345/157

(57) ABSTRACT

A pointing device includes a plurality of magnetic sensors and a point information generator. The point information generator generates one of positional information and moving information on a magnetic source based on outputs from the plurality of magnetic sensors.

### CROSS-REFERENCE TO RELATED APPLICATIONS

The present application claims priority under 35 U.S.C. §119 to Japanese Patent Application No. 2007-046222, filed Feb. 26, 2007, entitled “POINTING DEVICE, PORTABLE TERMINAL, POINT INFORMATION GENERATION METHOD, AND PORTABLE TERMINAL STRAP” The contents of this application are incorporated herein by reference in their entirety.

### BACKGROUND OF THE INVENTION

1. Field of the Invention

The present invention relates to a pointing device for inputting a position of a pointer using a magnetic force and to a portable terminal using the pointing device.

2. Description of the Related Art

There have been proposed and provided a variety of portable terminals such as mobile communication terminals including a PHS (personal handyphone system) and a mobile telephone, and information terminals including a PDA (personal digital assistant) and a GPS (global positioning system). Each of these portable terminals includes a display unit such as a liquid crystal display that serves as a display interface and a plurality of or many switches (keys) and a touch panel that serve as an input interface. A portable terminal of these types is configured so that a user can easily refer to and input information while he or she goes out.

Recently, in particular, the portable terminals have been increasingly improved functionally to follow technology advancement. For example, various applications including not only an application for referring to such a list as a telephone directory but also applications such as a web browser and games can run on the portable terminal. Quite naturally, after availability of these applications, a GUI (graphical user interface) has been adopted in the portable terminal.

On the GUI, an operation screen of each of the applications is arranged two-dimensionally. To use the GUI in a computer, a pointing device typified by a mouse is employed, and the computer is configured to specify a character input position using a mouse cursor or to input a point by, for example, clicking on a button. On the other hand, to use the GUI in a portable terminal, the point input method is hardly adopted since, for example, no space is secured to mount a pointing device and a display unit is smaller than that of a computer. Instead of adopting the point input method, the portable terminal is controlled to shift focus to a text box located at a specific position when a screen is scrolled up or down using a cross key.

Nevertheless, every user familiar with computer feels uncomfortable about the non-point input operation. Furthermore, since the point input operation is more intuitive and superior in operability, it is desired to employ some sort of pointing device in the portable terminal. However, to mount or connect a similar pointing device to that for the computer on or to the portable terminal, it is necessary to make keys to be included originally smaller in size or to make a housing larger in size. Such a pointing device disadvantageously hampers portability of the portable terminal assumed to be grasped by the user's hand when in use. Practical possibility of realizing such a portable terminal is low.

Conventionally, various pointing devices for the portable terminal have been already proposed. For example, a track ball is used as the pointing device on a portable terminal. A touch panel is used as the pointing device on a display unit so as to input a point by direct contact with an operation screen. Furthermore, a wireless mouse for computer is connected to a portable terminal (portable telephone).

### SUMMARY OF THE INVENTION

According to another aspect of the present invention, a portable terminal includes a housing, a plurality of magnetic sensors, a point information generator and a display unit. The plurality of magnetic sensors is arranged on one of a front surface and a back surface of the housing. The point information generator generates one of positional information and moving information on a magnetic source based on outputs from the plurality of magnetic sensors. The display unit displays an operation screen of an application.

According to further aspect of the present invention, a point information generation method comprises a step of generating positional information or moving information on a magnetic source according to outputs from a plurality of magnetic sensors.

According to further aspect of the present invention, a portable terminal strap includes a strap, an annular connector and a magnetic source. The strap is dangling a portable terminal. The annular connector connects the strap to the portable terminal. The magnetic source is placed at the strap.

### BRIEF DESCRIPTION OF THE DRAWINGS

FIG. 1 is an external perspective view of a portable terminal according to a first embodiment of the present invention;

FIG. 2 is a block diagram illustrating a configuration of a pointing device according to the first embodiment;

FIG. 3 is a schematic diagram explaining a strap according to the first embodiment;

FIG. 4 is a schematic diagram explaining a usage manner according to the first embodiment;

FIG. 5 is an external perspective view of a portable terminal according to a second embodiment of the present invention;

FIG. 6 is a block diagram explaining a configuration of a pointing device according to the second embodiment; and

FIG. 7 is a schematic diagram showing an example of a configuration in which magnetic force sensors are arranged on a back surface of a portable terminal according to another embodiment of the present invention.

### DESCRIPTION OF THE PREFERRED INVENTION

The inventor of the present invention made utmost efforts to study pointing devices applicable to portable terminals and discovered the following facts. Among currently available portable terminals, a folded terminal often includes therein a magnetic sensor (e.g., a hole device) detecting that the terminal is folded. The magnetic sensor is inexpensive and small in size. Due to this, even if a plurality of magnetic sensors is used, the influence of the sensors on cost efficiency and dimensions of housings is small. However, a single magnetic sensor can only detect a magnetic force (magnetic flux density) of a magnet or a change amount of the magnetic force, that is, the single magnetic sensor can determine only whether upper and lower housings separate from each other or contact with each other. If a plurality of magnetic sensors is arranged and intensities and ratios detected by the respective sensors or changes of the sensors which show the intensity more than the predetermined value are processed, it is possible to detect a moving direction and a moving amount of the magnet in the detection area. The inventor of the present invention finally completed the present invention.

### FIRST EMBODIMENT

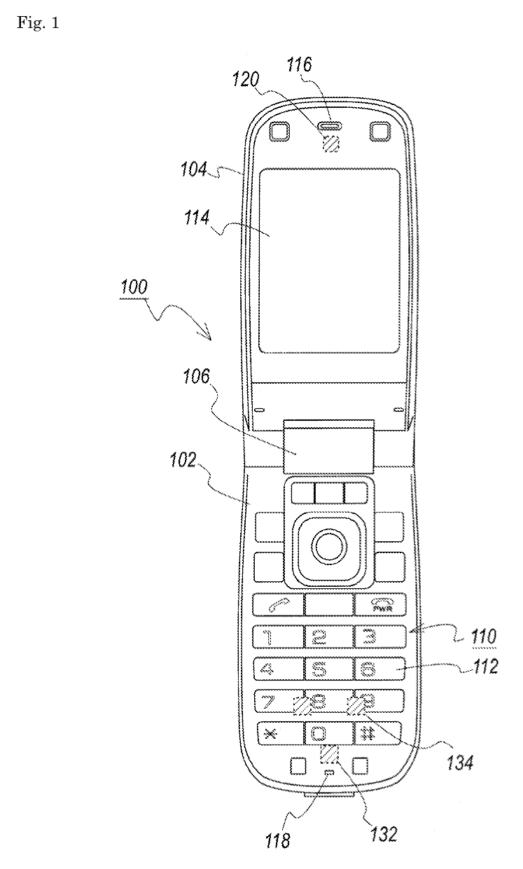

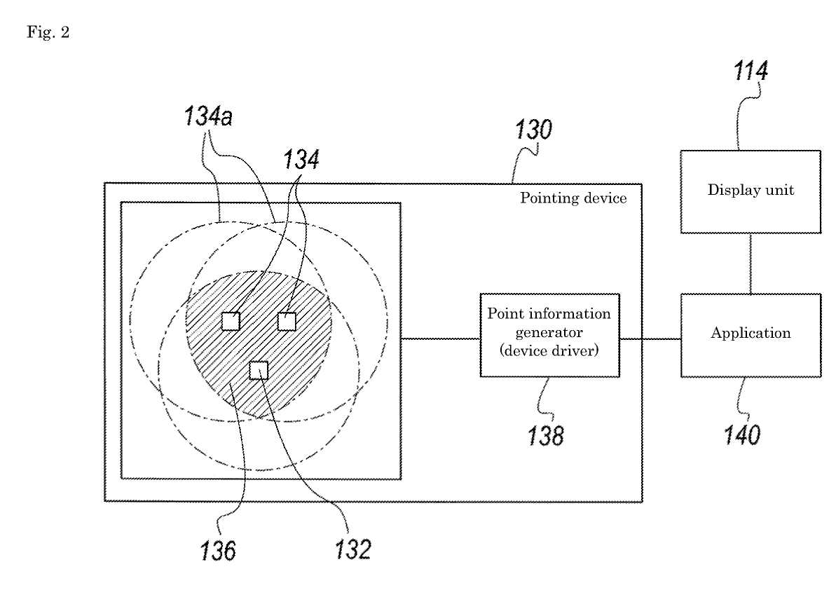

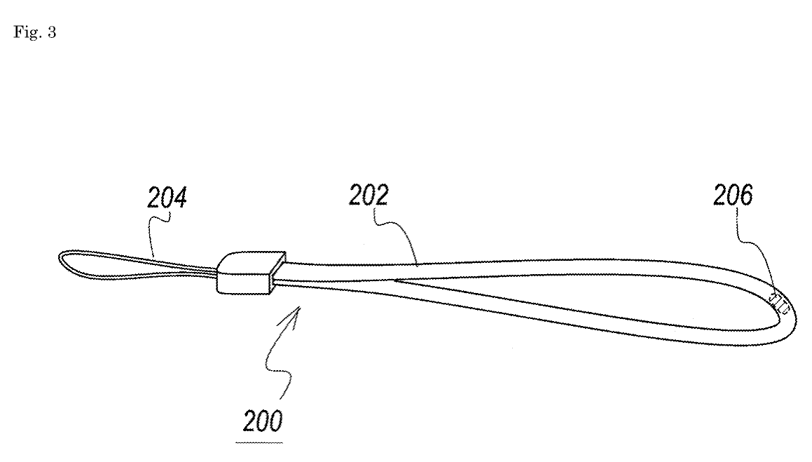

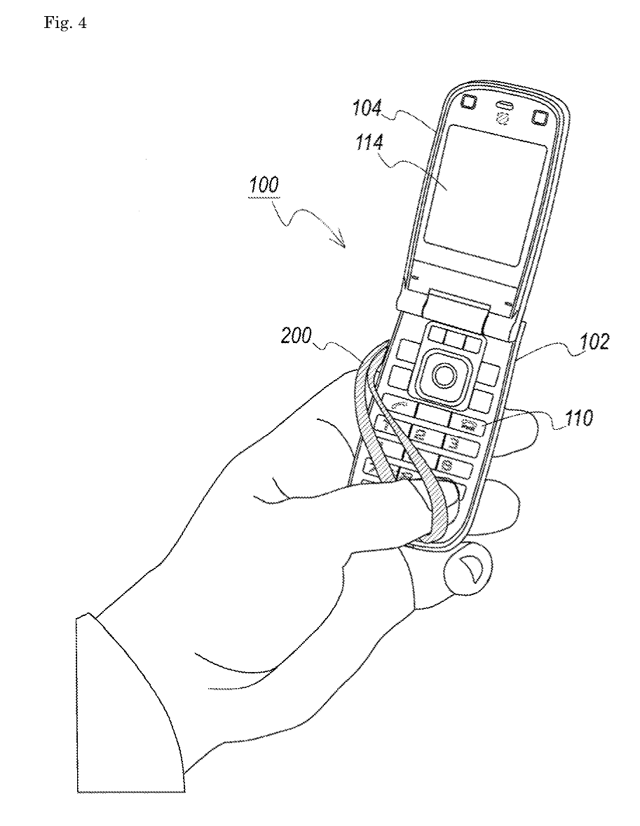

A pointing device, a portable terminal, and a potable terminal strap used for the pointing device or the portable terminal according to a first embodiment of the present invention will be described. FIG. 1 is an external perspective view of the portable terminal, FIG. 2 is a block diagram explaining a configuration of the pointing device, FIG. 3 is a schematic diagram explaining the strap, and FIG. 4 is a schematic diagram explaining a usage pattern. It is to be noted that dimensions, materials, other specific numeric values and the like shown in the embodiment are given only for illustrative purposes and not intended to limit the present invention unless specified otherwise.

The first embodiment is an example of magnetic sensors having an overlapped detection area.

A portable terminal 100 shown in FIG. 1, which is a PHS, is a so-called foldable portable communication terminal including a lower housing 102 that includes a main operating unit 110, an upper housing 104 that includes a display unit 114, and a hinge unit 106 rotatably connecting the lower housing 102 to the upper housing 104. On the main operating unit 110, a plurality of keys 112 such as dial keys is arranged. The display unit 114 displays a terminal operating state (a waiting state or a dial number) or each running application screen. A loudspeaker 116 is placed on an upper end of the upper housing 104, and a microphone 118 is placed on a lower end of the lower housing 102.

A user operates the main operating unit 110 to talk with using the loudspeaker 116 and the microphone 118. Likewise, the user operates the main operating unit 110 to perform email operation or to execute an application such as a web browser or games.

An open/close sensor 132 is on the lower end of the lower housing 102 and a magnet 120 is on the upper end of the upper housing 104. The open/close sensor 132 is a magnetic sensor, and the open/close sensor 132 and the magnet 120 are arranged at positions to face each other when the lower housing 102 and the upper housing 104 are closed. The portable terminal 100 can recognize that the housings 102 and 104 are closed if the open/close sensor 132 detects a magnetic force of the magnet 120. Consequently, the portable terminal performs a processing such as one for turning off the display unit 114 and changing to a waiting state.

A plurality of magnetic sensors 134 is arranged along a front surface of the lower housing 102. In the first embodiment, two magnetic sensors 134 are added, and the two magnetic sensors 134 and one open/close sensor 132 are arranged to be distributed into a triangular fashion. The expression “arranged to be distributed” means a state in which the three sensors are arranged to be away from one another lengthwise and crosswise, and examples of the state include a state of a polygon such as a triangle or a rectangle and a state of regular arrangement such as lattice state or a zigzag state. These magnetic sensors 134 are provided on a lower portion of the lower housing 102 (near the microphone 118), and a detection area 136 (to be described later) of the sensors 134 overlaps with the main operating unit 110.

As shown in FIG. 2, ranges of detection 134a of the respective magnetic sensors 134 are set to overlap with one another. To overlap the ranges of detection 134a, sensitivities of the magnetic sensors 134 and a distance among the magnetic sensors 134 are adjusted. In the first embodiment, the detection area 136 of the sensors 134 as that of a pointing device corresponds to a region in which the ranges of detection 134a of three magnetic sensors 134 overlap.

A point information generator 138 (device driver) generating positional information or moving information on a magnetic source according to outputs from the magnetic sensors 134 is connected to the magnetic sensors 134. Each of the magnetic sensors 134 converts a detected magnetic force into an electric signal and outputs the electric signal to the point information generator 138. The point information generator 138 takes into account both a ratio of signal intensities of the outputs from the three magnetic sensors 134 and positions of the respective magnetic sensors 134 (arrangement thereof), to specify an absolute position of a magnetic source in the detection area 136. If the magnetic sensors 134 pick up magnetism such as geomagnetism, influence of the earth magnetism can be eliminated by intensity correction. The intensity correction may be, for example, subtracting a lowest output value from output values of all the magnetic sensors 134.

Then, the point information generator 138 generates positional information on the magnetic source based on the specified absolute position of the magnetic source, and outputs the generated positional information to an application performing part (not shown) which performs an application to run on the portable terminal 100. The positional information may be the absolute position of the magnetic source itself, or a relative movement of coordinates. The open/close sensor 132, the magnetic sensors 134, and the point information generator 138 constitute a pointing device 130.

With the foregoing configuration, if a user holds the magnetic source (e.g., a magnet) by the hand and moves the magnetic source vertically and horizontally (lengthwise and crosswise along a front surface of the lower housing 102) while making the magnetic source proximate to the detection area 136 in which the open/close sensor 132 and the magnetic sensors 134 are arranged, the positional information or the moving information on the magnetic source can be detected. Furthermore, by allowing an application 140 to use the positional information or the moving information, it is possible to realize a function similar to a mouse function for specifying a position.

In this embodiment, only a few small magnetic sensors 134 are added to the portable terminal 100. The magnetic sensors 134 are small in size and noncontact sensors, so that the magnetic sensors 134 can be arranged in the housing(s) (that is, the magnetic sensors 134 do not occupy a surface of the portable terminal 100). Furthermore, a degree of freedom for arranging magnetic sensors is high and the portable terminal 100 is not made larger in size. Moreover, since the magnetic sensors 134 are not movable component, good durability can be ensured. Besides, the magnetic sensors 134 are inexpensive and the number of the magnetic sensors 134 is small, so that it is possible to suppress an increase in manufacturing cost to be small. As compared particularly with an instance of adopting a track ball or a touch panel, the portable terminal 100 can be manufactured at low cost.

The fact that the magnetic sensors 134 can be arranged to overlap with the region of the main operating unit 110, in particular, follows that no occupation area is necessary on the surface of the housings 102 and 104. This is quite advantageous to the portable terminal having a limited surface area. Further, because of no change in a surface of the main operating unit 110, the user does not feel uncomfortable. Moreover, the user operates the pointing device 130 with the magnet held by the hand. Due to this, the transition from the operation of the pointing device 130 by tracing an upper portion of the main operating unit 110 to character input operation using the keys 112 or vice versa, can be made smooth, exhibiting good operativity.

How to use the information output from the point information generator 138 depends on a configuration of the application 140. If the application 140 for a web browser, an editor and the like, is executed, for example, then the information can be used to control a mouse cursor and to specify an arbitrary position on the screen similarly to a computer. If the screen is designed to be scrolled, the screen can be scrolled up or down according to the information output from the point information generator 138. A user can perform the point input operation in a similar manner or sense to the familiar mouse, thereby the pointing device 130 will be user-friendly.

As shown in FIG. 3, a magnet can be attached to the strap. The magnet is provided apart from the portable terminal 100. Due to this, if the magnet is completely separate from the portable terminal 100, the user needs to carry the portable terminal 100 and the magnet individually. This may possibly make the user feel reluctant to take out the magnet or cause the user to lose the magnet. However, if the magnet is attached to the strap which is conventionally attached to the portable terminal, the user can always carry the magnet without regard to the magnet.

A strap 200 shown in FIG. 3 includes a strap unit 202 dangling the portable terminal 100 and an annular connector 204 connecting the strap unit 202 to the portable terminal 100. In the first embodiment, the strap unit 202 is also annular and contains a magnet 206 serving as a magnetic source in a tip end thereof (opposite to the connector 204). The magnet 206 can be attached to the strap 200 by sewing or bonding the magnet 206 to the strap unit 202.

As shown in FIG. 4, if the user traces the surface of the lower housing 102 using the magnet 206 attached to the strap 200 with the strap 200 kept connected to the portable terminal 100, point input operation can be carried out. The user can operate the magnet 206 while picking up the magnet 206 between the user's fingers. However, if the strap unit 202 is annular as shown in the first embodiment, the user can appropriately perform the point input operation with one finger by putting the finger through the annular strap unit 202 as shown in FIG. 4.

That is, by providing the magnet 206 serving as the magnetic source on or in the strap 200, the user can always carry the magnet 206 together with the portable terminal 100, thereby making it possible to prevent loss of the magnet 206 and to promptly start input operation. Moreover, if the strap unit 202 is tubular, the magnet 206 can be sewed into the strap unit 202. In this case, the strap 200 hardly changes externally and the user does not feel uncomfortable.

With the configuration of the first embodiment, the open/close sensor 132 is also used for position detection. Due to this, if the open/close sensor 132 is always controlled to detect whether the upper housing 104 is closed, the open/close sensor 132 may possibly erroneously recognize that the upper housing 104 is closed when the magnet 206 is moved to the position of the open/close sensor 132. To avoid such misrecognition, the open/close sensor 132 is controlled so that the magnetic force detected by the open/close sensor 132 is used only for position detection of the pointing device 130 while the application 140 uses the pointing device 130. The portable terminal 100 may be configured so that which application 140 uses the pointing device 130 is set in advance or so that the user can select one application as the application 140 using the pointing device 130.

### SECOND EMBODIMENT

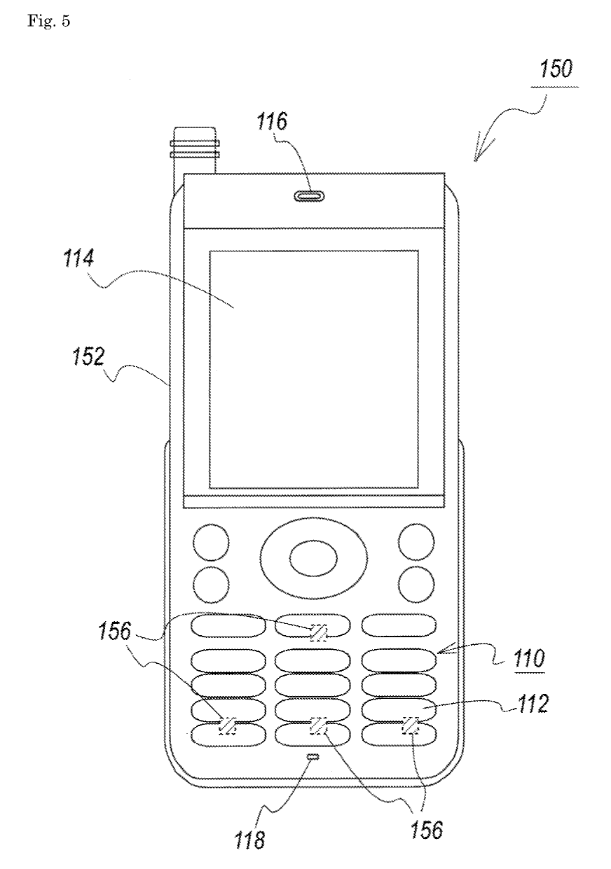

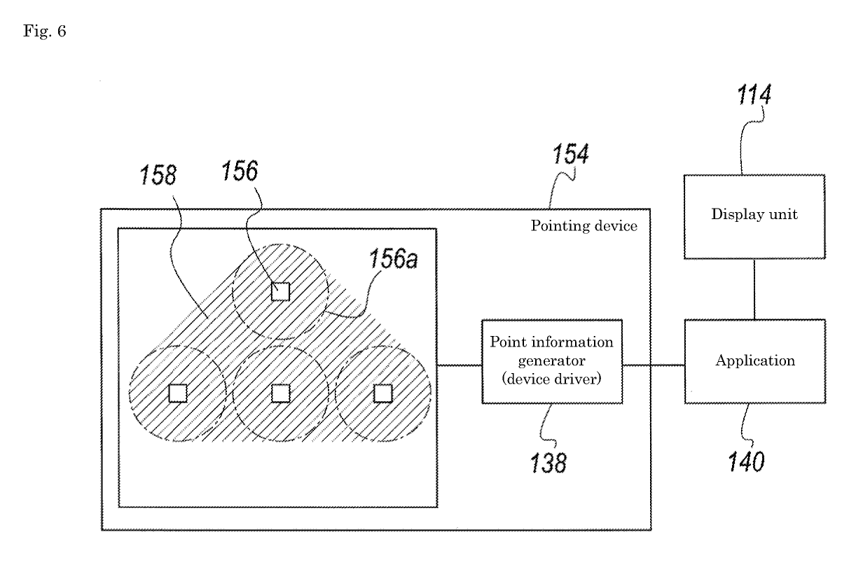

A pointing device and a portable terminal according to a second embodiment of the present invention will be described. FIG. 5 is an external perspective view of the portable terminal according to the second embodiment. FIG. 6 is a block diagram explaining a configuration of the pointing device according to the second embodiment. The same constituent elements as those according to the first embodiment are denoted by the same reference numerals and will not be repeatedly described herein.

In the first embodiment, the open/close sensor 132 and the magnetic sensors 134 are arranged so that the ranges of detection 134a overlap with one another (see FIG. 2). However, a magnetic sensor having high sensitivity is relatively expensive and possibly picks up the earth magnetism, disturbance or the like, resulting in complicated processing. In the second embodiment, therefore, a configuration in which ranges of detection of magnetic sensors do not overlap with one another or in which even if the ranges of detection of magnetic sensors partially (slightly) overlap, processing is performed while assuming that the ranges of detection do not overlap will be described.

A portable terminal 150 shown in FIG. 5 is a so-called straight portable communication terminal. A loudspeaker 116 is placed on an upper end of a housing 152 and a microphone 118 is placed on a lower end thereof. A main operating unit 110 is arranged in a lower portion on a front surface of the housing 152, and a display unit 114 is placed in an upper portion thereof.

A plurality of magnetic sensors 156 is provided along the front surface of the housing 152. In the second embodiment, four magnetic sensors 156 are added to be arrange and distributed into an inverse T shape. Similarly to the first embodiment, the magnetic sensors 156 are provided in the lower portion of the housing 152 (near the microphone 118), and a part of a range of detection 158 overlaps with the inside region of the main operating unit 110.

As shown in FIG. 6, a pointing device 154 according to the second embodiment has ranges of detection 156a of the magnetic sensors 156, each of which do not overlap that of the ranges of detection 156a of the adjacent sensors 156. The reason for such a configuration is as follows. The magnetic sensors 156 may be low in sensitivity or a distance among the magnetic sensors 156 may be large. In the second embodiment, the range of detection 158 of the pointing device 154 corresponds not to an overlapping part of the ranges of detection as described in the first embodiment but to an outermost edge of the ranges of detection 156a of all the magnetic sensors 156.

Each of the magnetic sensors 156 converts a detected magnetic force into an electric signal and outputs the electric signal to a point information generator 138. Since the ranges of detection 156a do not overlap, only one magnetic sensor 156 outputs the electric signal to the point information generator 138. If the electric signals are output from two or more magnetic sensors 156, the point information generator 138 selects the highest level signal. The point information generator 138 measures time using a time measuring unit (not shown) such as a timer. If receiving an output from another magnetic sensor 156 in predetermined time since receiving an output from one magnetic sensor 156, the point information generator 138 determines that a magnetic source has moved in a direction of the other magnetic sensor 156. That is, the point information generator 138 does not receive information on a moving amount but receive only a moving direction.

The point information generator 138 generates moving information on the magnetic source based on the specified moving direction of the magnetic source, and outputs the generated moving information to an application 140. As the moving information, the acquired moving direction can be output as it is or the acquired moving direction combined with a predetermined moving amount set can be output.

The application 140 can exert various controls using the moving information received from the pointing device 154. For example, the moving information can be used for scrolling control over a web browser, volume control over music play software or command input control for games.

From viewpoints of a user, he or she can perform a point input operation in a similar manner or sense to the familiar mouse, thereby making the pointing device 154 user-friendly. Moreover, as compared with the first embodiment, cost reduction can be realized using inexpensive magnetic sensors, and improved operability can be ensured by increasing an area of the range of detection.

In the second embodiment, the ranges of detection 156a do not overlap each other. However, the ranges of detection 165a may overlap each other to the point input operation corresponding to the second embodiment using the highest level signal. Furthermore, in this case, the operation may be switched from detecting the moving amount to detecting the moving direction and vice versa.

### ANOTHER EMBODIMENT

In the first and second embodiments, the magnetic sensors 134 or 156 are provided on a front surface of the portable terminal 100 or 150. However, the present invention is not limited to the embodiments and the magnetic sensors can be arranged on a back surface of the portable terminal.

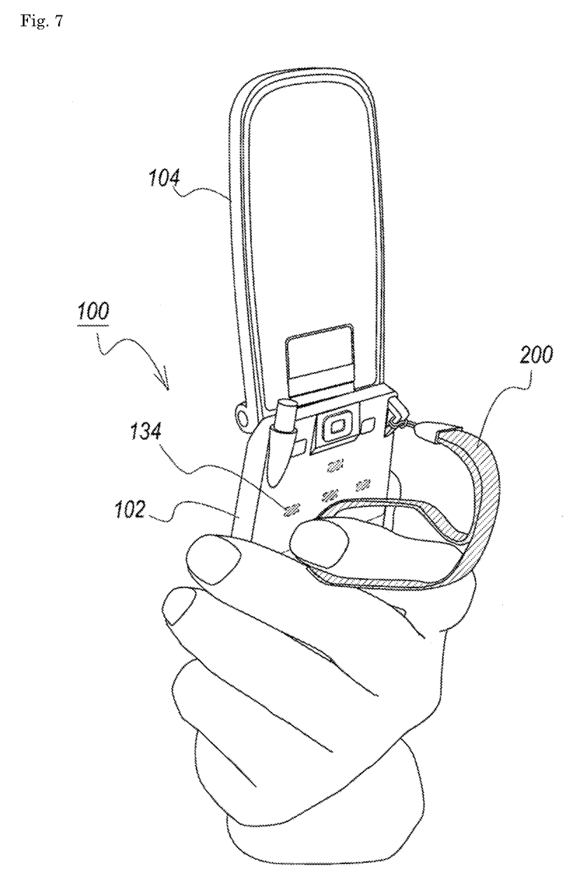

FIG. 7 is a schematic diagram showing an example of a configuration in which magnetic sensors are arranged on the back surface of the portable terminal. A plurality of magnetic sensors 134 is arranged to be distributed along the back surface of the lower housing 102. By moving a magnet in ranges of detection of the magnetic sensors 134, the user can perform point input operation similarly to the first and second embodiments. It thereby suffices that the user may keep touching the magnet by the fingers even when the point input operation changes to character input operation. Therefore, transition of operation can be made smoother.

In the first and second embodiments, the configuration in which the magnetic sensors are arranged lengthwise and crosswise has been described. Alternatively, only two magnetic sensors can be provided for scrolling control. In this alternative, the magnetic sensors can be arranged on a side surface of one of the housings. In another alternative, the number of magnetic sensors is not limited to four or five but more magnetic sensors can be arranged in a distributed fashion (e.g., arranged to correspond to respective corners of the keys). This can improve accuracy for position detection. For example, the number of magnetic sensors is nine and ranges of detection of some sensors among nine sensors overlaps each other to perform the operation described in the first embodiment and ranges of detection of the other sensors do not overlap each other to perform the operation described in the second embodiment. Consequently, both a moving amount and a moving direction may be obtained.

The preferred embodiments of the present invention have described so far with reference to the accompanying drawings. Needless to say, the present invention is not limited to these embodiments. It is obvious that a person having ordinary skill in the art could be easily motivated to attain various changes or modifications within the scope of the invention as defined in the claims that follow. Accordingly, such modifications and variations are, unless they depart from the scope of the present invention as delivered from the claims appended hereto, to be construed as included therein.

For example, in the embodiments, the portable terminal is a PHS. However, the present invention is also applicable to various other information terminals including a mobile communication terminal such as a portable telephone, a PDA, a GPS, and a notebook computer, and it is possible to enjoy benefits of the present invention. This invention may be applied to remote controllers for TV, DVD, video games or other electric products.

The present invention can be used as a pointing device inputting a position of a pointer using a magnetic force and a portable terminal using the pointing device.

What is claimed is:

1. A pointing device comprising:
a plurality of magnetic sensors; and
a point information generator generating one of positional information and moving information on a magnetic source based on outputs from the plurality of magnetic sensors.

2. The pointing device according to claim 1,
wherein three out of the plurality of magnetic sensors are arranged at vertices of a triangle, respectively.

3. The pointing device according to claim 1,
wherein at least two out of the plurality of magnetic sensors have overlapped ranges of detecting the magnetic source, and the point information generator generates the positional information on the magnetic source based on outputs from the at least two magnetic sensors that have detected the magnetic source.

4. The pointing device according to claim 1,
wherein the point information generator generates the moving information using an order of two or more magnetic sensors that have detected the magnetic source.

5. The pointing device according to claim 4,
wherein number of the plurality of magnetic sensors is three.

6. The pointing device according to claim 4,
wherein number of the plurality of magnetic sensors is four.

7. The pointing device according to claim 4,
wherein number of the plurality of magnetic sensors is two.

8. The pointing device according to claim 7,
wherein the point information generator generates one-dimensional positional information.

9. A portable terminal comprising:
a housing;
a plurality of magnetic sensors arranged on one of a front surface and a back surface of the housing;
a point information generator generating one of positional information and moving information on a magnetic source based on outputs from the plurality of magnetic sensors; and
a display unit displaying an operation screen of an application.

10. The portable terminal according to claim 9,
wherein the plurality of magnetic sensors is arranged inside of a main operating unit on which a plurality of keys lays out.

11. The portable terminal according to claim 9, further comprising the magnetic source.

12. A point information generation method comprising a step of generating positional information or moving information on a magnetic source according to outputs from a plurality of magnetic sensors.

13. The point information generation method according to claim 12, wherein the positional information on the magnetic source is generated using a ratio of detection intensities of outputs from two or more out of the magnetic sensors that have detected the magnetic source.

14. The point information generation method according to claim 12, wherein the moving information is generated using an order of two or more out of the magnetic sensors that have detected the magnetic source.

15. A portable terminal strap comprising:
a strap dangling a portable terminal;
an annular connector connecting the strap to the portable terminal; and
a magnetic source arranged at the strap.

16. The portable terminal strap according to claim 15,
wherein the magnetic source is a magnet.

17. A pointing device comprising:
measuring means for measuring magnetism from a magnetic source;
information generating means for generating information on moving amount or moving direction of the magnetic source based on the measured magnetism; and
a display showing a location of a pointer based on the generated information.
